(19) United States
(12) Patent Application Publication
(10) Pub. No.: US 2017/0294995 A1
(43) Pub. Date: Oct. 12, 2017

(54) DATA TRANSMISSION METHODS AND APPARATUSES, PRIMARY NODE, AND SECONDARY NODE

(71) Applicant: ZTE CORPORATION, Shenzhen, Guangdong Provinec (CN)

(72) Inventors: Liu YANG, Shenzhen, Guangdong Province (CN); Kaibo TIAN, Shenzhen, Guangdong Province (CN); Weimin XING, Shenzhen, Guangdong Province (CN)

(73) Assignee: ZTE Corporation, Shenzhen, Guangdong Province (CN)

(21) Appl. No.: 15/511,452

(22) PCT Filed: Jun. 5, 2015
(86) PCT No.: PCT/CN2015/080917

§ 371 Date: Mar. 15, 2017

(30) Foreign Application Priority Data
Sep. 19, 2014 (CN) 201410484697.4

(51) Int. Cl. H04L 5/00; H04W 72/04

(52) U.S. Cl. CPC H04L 5/0007; H04W 72/0446; H04W 84/12

(57) ABSTRACT

Provided are data transmission methods and apparatuses, a primary node, and a secondary node. In the data transmission method, a data transmission opportunity is obtained; and a radio frame is sent to at least one secondary node, wherein a signalling field of the radio frame contains indication information used for indicating that the radio frame is transmitted via an Orthogonal Frequency Division Multiple Access (OFDMA) transmission mode.

### TECHNICAL FIELD

The present disclosure relates to the field of communications, and in particular to data transmission methods and apparatuses, a primary node, and a secondary node.

### BACKGROUND

At present, it is very common to perform data communication via a Wireless Local Area Network (WLAN). The Institute of Electrical and Electronic Engineers (IEEE) 802.11 defines a series of standards such as 802.11a/b/g/n/ac in sequence to meet increasing communication demands. FIG. 1 is a schematic diagram of a Basic Service Set (BSS) of a WLAN in the related art. As shown in FIG. 1, in the WLAN, one Access Point (AP) and multiple non-AP Stations (non-AP STA) associated with this AP form one BSS, as shown in FIG. 1. The AP is provided with a certain working bandwidth, for example, a 20 MHz working bandwidth is supported by 802.11a/b/g, a 20/40 MHz working bandwidth is supported by 802.11n, and a 20/40/80/160 MHz is supported by 802.11ac. One 20 MHz channel within the supported working bandwidth serves as a main channel of the AP. The AP sends a beacon frame on the main channel to broadcast the presence of the present BSS.

With the increase of number of users, the efficiency of the WLAN trends to be obviously reduced. Reasons for reduction of the efficiency of the WLAN specifically include the following items.

1. The WLAN belongs to a time division system, each station obtains a right to use a channel through contention, and only one station is allowed to send data at a certain time. When a station monopolizes the channel for data transmission, other stations have to keep silent, and cannot reuse the channel within the same period of time to perform parallel transmission.

2. In the WLAN, maximum bandwidths supported by standards of all versions are different. For example, 802.11a/b/g maximally supports a 20 MHz bandwidth, 802.11n maximally supports a 40 MHz bandwidth, and 802.11ac may support a 160 MHz bandwidth maximally. Moreover, regardless of the size of the bandwidth used for data transmission, the station has to use channels including a main channel.

Specifically, supposing that a current working bandwidth of the AP maximally supports 80 MHz, when a small-bandwidth station (e.g., 802.11g device) sends data to the AP, a 20 MHz main channel is enough for the data transmission. However, other stations cannot use residual bandwidth resources to perform parallel transmission within the same period of time, which results in a waste of bandwidth resources.

Therefore, the problems of low efficiency and waste of resources in data transmission of a WLAN exist in the related art.

### SUMMARY

The embodiments of the present disclosure provide data transmission methods and apparatuses, a primary node, and a secondary node, which are intended to at least solve the problems of low efficiency and waste of resources existing in data transmission of a WLAN in the related art.

According to an aspect of the embodiments of the present disclosure, a data transmission method is provided, which may include that: a data transmission opportunity is obtained; and a radio frame is sent to at least one secondary node, wherein a signalling field of the radio frame contains indication information used for indicating that the radio frame is transmitted via an Orthogonal Frequency Division Multiple Access (OFDMA) transmission mode.

In an exemplary embodiment of the present disclosure, the at least one secondary node may include the following combination modes: one or more second-class secondary nodes supporting an OFDMA transmission technology, and one or more first-class secondary nodes; and one or more second-class secondary nodes supporting an OFDMA transmission technology.

In an exemplary embodiment of the present disclosure, the signalling field of the radio frame may include at least one of: a Legacy SIGNAL (L-SIG), a High-Throughput SIGNAL (HT-SIG), a Very-High-Throughput SIGNAL (VHT-SIG), and a High-Effective SIGNAL (HE-SIG).

In an exemplary embodiment of the present disclosure, the radio frame may be sent to the one or more second-class secondary nodes in the at least one secondary node in a predetermined format, the predetermined format including at least one of: a format 1-a in which a signalling field corresponding to the one or more second-class secondary nodes is located after a signalling field corresponding to the one or more first-class secondary nodes; a format 1-b in which a channel estimation sequence is added ahead of a signalling field corresponding to the one or more second-class secondary nodes; and a format 2-a in which only a signalling field corresponding to the one or more second-class secondary nodes is contained.

In an exemplary embodiment of the present disclosure, the signalling field of the radio frame may further include at least one of: usage band range information of the one or more second-class secondary nodes in the at least one secondary node, and identity authentication information of the one or more second-class secondary nodes.

According to another aspect of the embodiments of the present disclosure, a data transmission method is provided, which may include that: a radio frame sent by a primary node is received, wherein a signalling field of the radio frame contains indication information used for indicating that the radio frame is transmitted via an OFDMA transmission mode; it is detected, over a main channel of the primary node, that a transmission mode of current transmission is the OFDMA transmission mode; information of a corresponding channel used for transmitting data by the primary node is acquired according to detection on the main channel; and the data transmitted by the primary node is acquired on the corresponding channel.

In an exemplary embodiment of the present disclosure, the signalling field of the radio frame may include at least one of: an L-SIG, an HT-SIG, a VHT-SIG, and an HE-SIG.

In an exemplary embodiment of the present disclosure, the radio frame sent by the primary node may be received in a predetermined format, the predetermined format including at least one of: a format 1-a in which a signalling field corresponding to one or more second-class secondary nodes is located after a signalling field corresponding to one or more first-class secondary nodes; a format 1-b in which a channel estimation sequence is added ahead of a signalling field corresponding to the one or more second-class secondary nodes; and a format 2-a in which only a signalling field corresponding to the one or more second-class secondary nodes is contained.

In an exemplary embodiment of the present disclosure, the signalling field of the radio frame may further include at least one of: usage band range information of the one or more second-class secondary nodes, and identity authentication information of the one or more second-class secondary nodes.

According to another aspect of the embodiments of the present disclosure, a data transmission apparatus is provided, which may include: an obtaining module, arranged to obtain a data transmission opportunity; and a sending module, arranged to send a radio frame to at least one secondary node, wherein a signalling field of the radio frame contains indication information used for indicating that the radio frame is transmitted via an OFDMA transmission mode.

According to a further aspect of the embodiments of the present disclosure, a primary node is provided, which may include the above-mentioned apparatus.

According to a further aspect of the embodiments of the present disclosure, a data transmission apparatus is provided, which may include: a receiving module, arranged to receive a radio frame sent by a primary node, wherein a signalling field of the radio frame contains indication information used for indicating that the radio frame is transmitted via an OFDMA transmission mode; a detection module, arranged to detect, over a main channel of the primary node, that a transmission mode of current transmission is the OFDMA transmission mode; a first acquisition module, arranged to acquire, according to detection on the main channel, information of a corresponding channel used for transmitting data by the primary node; and a second acquisition module, arranged to acquire the data transmitted by the primary node on the corresponding channel.

According to a further aspect of the embodiments of the present disclosure, a secondary node is provided, which may support an OFDMA transmission technology and may include the above-mentioned apparatus.

By means of the embodiments of the present disclosure, a data transmission opportunity is obtained; and a radio frame is sent to at least one secondary node, wherein a signalling field of the radio frame contains indication information used for indicating that the radio frame is transmitted via an OFDMA transmission mode. The problems of low efficiency and waste of resources existing in data transmission of a WLAN in the related art are solved, thereby achieving the effect of improving network efficiency effectively by using an OFDMA transmission mode in the WLAN.

### BRIEF DESCRIPTION OF THE DRAWINGS

The drawings described herein are intended to provide further understanding of the present disclosure, and form a part of the present application. The schematic embodiments and descriptions of the present disclosure are intended to explain the present disclosure, and do not form improper limits to the present disclosure. In the drawings:

FIG. 1 is a schematic diagram of a BSS of a WLAN in the related art;

FIG. 2 is a flowchart of a data transmission method 1 according to an embodiment of the present disclosure;

FIG. 3 is a flowchart of a data transmission method 2 according to an embodiment of the present disclosure;

FIG. 4 is a structural diagram of a data transmission apparatus 1 according to an embodiment of the present disclosure;

FIG. 5 is a structural diagram of a primary node according to an embodiment of the present disclosure;

FIG. 6 is a structural diagram of a data transmission apparatus 2 according to an embodiment of the present disclosure;

FIG. 7 is a structural diagram of a secondary node according to an embodiment of the present disclosure;

FIG. 8 is a schematic diagram of channel planning for OFDMA transmission according to an embodiment of the present disclosure;

FIG. 9 is a sample graph of OFDMA transmission via a frame format “1-a” according to an embodiment of the present disclosure;

FIG. 10 is a sample graph 1 of OFDMA transmission via a frame format “1-b” according to an embodiment of the present disclosure;

FIG. 11 is a sample graph 2 of OFDMA transmission via a frame format “1-b” according to an embodiment of the present disclosure;

FIG. 12 is a sample graph 3 of OFDMA transmission via a frame format “1-b” according to an embodiment of the present disclosure;

FIG. 13 is a sample graph 4 of OFDMA transmission via a frame format “1-b” according to an embodiment of the present disclosure;

FIG. 14 is a sample graph 5 of OFDMA transmission via a frame format “1-b” according to an embodiment of the present disclosure; and

FIG. 15 is a sample graph of OFDMA transmission via a frame format “2-a” according to an embodiment of the present disclosure.

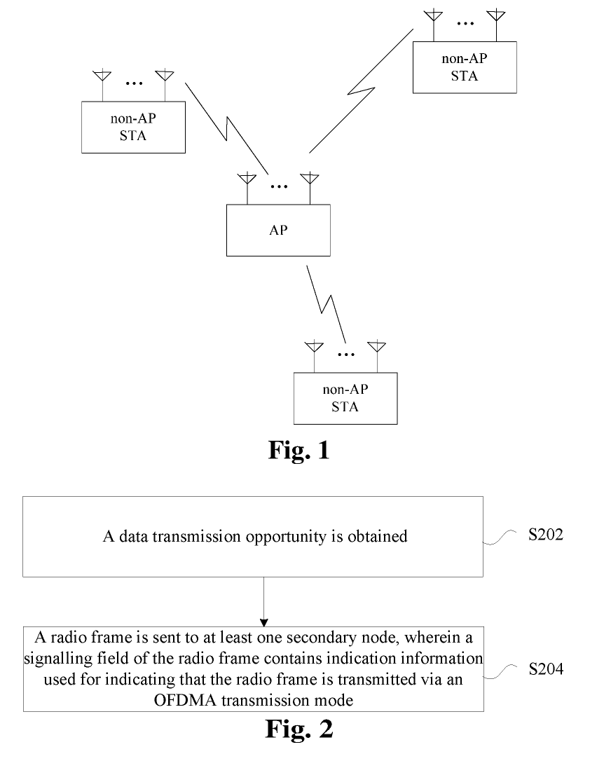

### DETAILED DESCRIPTION OF THE EMBODIMENTS

The present disclosure will be described in detail below with reference to the drawings and the embodiments. It is important to note that the embodiments in the present application and the characteristics in the embodiments may be combined without conflicts.

A data transmission method is provided in the present embodiment. FIG. 2 is a flowchart of a data transmission method 1 according to an embodiment of the present disclosure. As shown in FIG. 2, the flow includes the following steps.

At Step S202, a data transmission opportunity is obtained.

At Step S204, a radio frame is sent to at least one secondary node, and a signalling field of the radio frame contains indication information used for indicating that the radio frame is transmitted via an OFDMA transmission mode. It is important to note that the indication information may be contained in the signalling field of the radio frame by using multiple modes. For example, when the signalling field of the radio frame is not expanded or replicated, the indication information may be carried in the non-expanded or non-replicated signalling field of the radio frame. For another example, when the signalling field of the radio frame is expanded, the indication information may be carried in the expanded signalling field. For another example, when the signalling field of the radio frame is replicated, the indication information may also be carried in the duplicate signalling field obtained by replication.

By means of the above-mentioned steps, the radio frame sent to the secondary node contains the indication information used for indicating that the radio frame is transmitted via the OFDMA transmission mode, such that when receiving the radio frame, the secondary node performs channel detection according to the indication information and acquires corresponding transmission data. Compared with the related art, the technical scheme provided by the embodiment of the present disclosure solves, by using the OFDMA transmission mode in the WLAN, the problems of low efficiency and waste of resources existing in data transmission of a WLAN in the related art. The network efficiency is effectively improved.

The at least one secondary node may be embodied as multiple combination modes. For example, the at least one secondary node may include one of the following combination modes. One combination mode is formed by one or more first-class secondary nodes (i.e., legacy device, the legacy device not supporting the OFDMA transmission technology) only supporting an 802.11a/b/g/n/ac protocol and one or more second-class secondary nodes (i.e., new device, supporting the OFDMA transmission technology) supporting the 802.11a/b/g/n/ac protocol and an OFDMA transmission technology. Another combination mode is formed by one or more second-class secondary nodes supporting the 802.11a/b/g/n/ac protocol and the OFDMA transmission technology.

There may be multiple types of signalling fields of the radio frame according to different supported protocols. For example, the signalling field may include at least one of: an L-SIG, an HT-SIG, a VHT-SIG, and an HE-SIG.

The radio frame may be sent to the one or more second-class secondary nodes in the at least one secondary node in multiple predetermined formats. The predetermined format may include at least one of: a format 1-a in which a signalling field corresponding to the one or more second-class secondary nodes is located after a signalling field corresponding to the one or more first-class secondary nodes; a format 1-b in which a channel estimation sequence is added ahead of a signalling field corresponding to the one or more second-class secondary nodes; and a format 2-a in which only a signalling field corresponding to the one or more second-class secondary nodes is contained.

The signalling field of the radio frame may include multiple pieces of information. For example, the signalling field may include at least one of: usage band range information of the one or more second-class secondary nodes in the at least one secondary node, and identity authentication information of the one or more second-class secondary nodes.

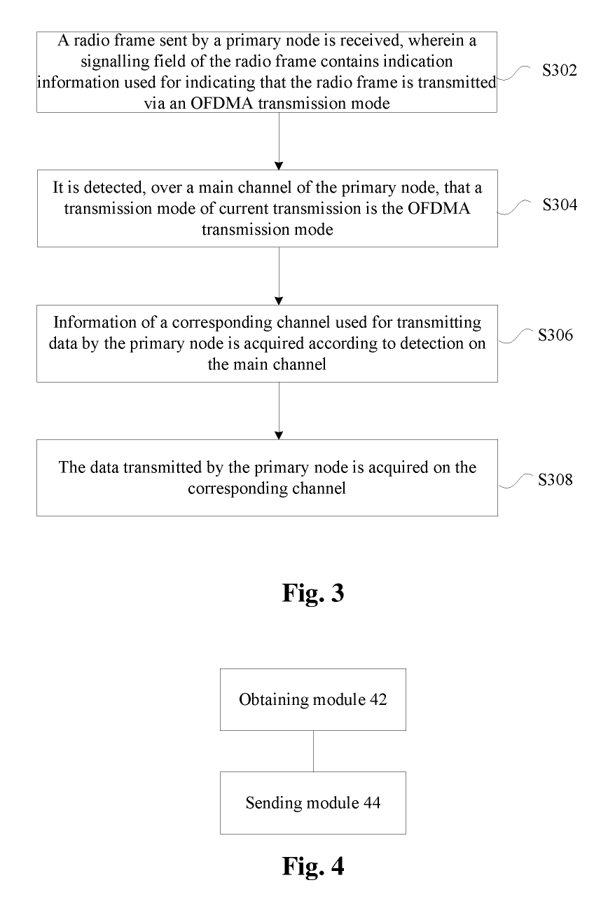

FIG. 3 is a flowchart of a data transmission method 2 according to an embodiment of the present disclosure. As shown in FIG. 3, the flow includes the following steps.

At Step S302, a radio frame sent by a primary node is received, and a signalling field of the radio frame contains indication information used for indicating that the radio frame is transmitted via an OFDMA transmission mode.

At Step S304, it is detected, over a main channel of the primary node, that a transmission mode of current transmission is the OFDMA transmission mode.

At Step S306, information of a corresponding channel used for transmitting data by the primary node is acquired according to detection on the main channel.

At Step S308, the data transmitted by the primary node is acquired on the corresponding channel.

By means of the above-mentioned steps, the indication information used for indicating that the radio frame is transmitted via the OFDMA transmission mode is received in the radio frame sent by the primary node, such that channel detection can be performed according to the indication information in the radio frame, and corresponding transmission data is acquired. Compared with the related art, the technical scheme provided by the embodiment of the present disclosure solves, by using the OFDMA transmission mode in the WLAN, the problems of low efficiency and waste of resources existing in data transmission of a WLAN in the related art. The network efficiency can be effectively improved.

Correspondingly, the signalling field of the radio frame may include at least one of: an L-SIG, an HT-SIG, a VHT-SIG, and an HE-SIG.

The radio frame sent by the primary node may be received in a predetermined format. The predetermined format may include at least one of: a format 1-a in which a signalling field corresponding to one or more second-class secondary nodes is located after a signalling field corresponding to one or more first-class secondary nodes; a format 1-b in which a channel estimation sequence is added ahead of a signalling field corresponding to the one or more second-class secondary nodes; and a format 2-a in which only a signalling field corresponding to the one or more second-class secondary nodes is contained.

The signalling field of the radio frame may further include at least one of: usage band range information of the one or more second-class secondary nodes in the at least one secondary node, and identity authentication information of the one or more second-class secondary nodes.

A data transmission apparatus is also provided in the present embodiment. The data transmission apparatus is arranged to implement the above-mentioned embodiment and an exemplary implementation mode. Those which have been illustrated will not be elaborated herein. A term “module” used below may be implemented by the combination of software and/or hardware with predetermined functions. Although the data transmission apparatus described by the following embodiment is better implemented by software, the implementation of hardware or the combination of software and hardware may be possible and conceived.

FIG. 4 is a structural diagram of a data transmission apparatus 1 according to an embodiment of the present disclosure. As shown in FIG. 4, the data transmission apparatus includes an obtaining module 42 and a sending module 44. The data transmission apparatus will be illustrated below.

The obtaining module 42 is arranged to obtain a data transmission opportunity.

The sending module 44 is coupled to the obtaining module 42, and is arranged to send a radio frame to at least one secondary node, and a signalling field of the radio frame contains indication information used for indicating that the radio frame is transmitted via an OFDMA transmission mode.

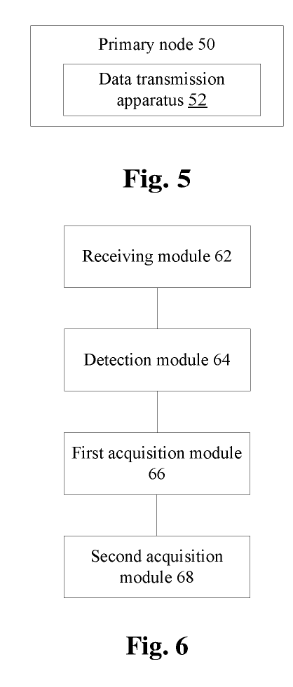

FIG. 5 is a structural diagram of a primary node according to an embodiment of the present disclosure. As shown in FIG. 5, the primary node 50 includes the data transmission apparatus 52.

FIG. 6 is a structural diagram of a data transmission apparatus 2 according to an embodiment of the present disclosure. As shown in FIG. 6, the data transmission apparatus includes: a receiving module 62, a detection module 64, a first acquisition module 66 and a second acquisition module 68. The data transmission apparatus will be illustrated below.

The receiving module 62 is arranged to receive a radio frame sent by a primary node, and a signalling field of the radio frame contains indication information used for indicating that the radio frame is transmitted via an OFDMA transmission mode. The detection module 64 is coupled to the receiving module 62, and is arranged to detect, over a main channel of the primary node, that a transmission mode of current transmission is the OFDMA transmission mode. The first acquisition module 66 is coupled to the detection module 64, and is arranged to acquire, according to detection on the main channel, information of a corresponding channel used for transmitting data by the primary node. The second acquisition module 68 is coupled to the first acquisition module 66, and is arranged to acquire the data transmitted by the primary node on the corresponding channel.

FIG. 7 is a structural diagram of a secondary node according to an embodiment of the present disclosure. As shown in FIG. 7, the secondary node 70 supports an 802.11a/b/g/n/ac protocol and an OFDMA transmission technology, and includes the data transmission apparatus 72.

In the related art, an OFDMA technology is able to implement parallel transmission of multiple stations on multiple channels. A process of transmission via the OFDMA technology in a WLAN may be implemented in the following manner. Multiple secondary nodes send data to a primary node simultaneously or the primary node sends data to multiple secondary nodes simultaneously. The primary node may be an AP or a special-capability non-AP STA, and the secondary nodes may be non-AP STAs generally. In such a case, one BSS contains legacy devices (collectively referred to as first-class devices) supporting 802.11a/b/g/n/ac, and new devices (collectively referred to as second-class devices) backwardly compatible with the above-mentioned standard and also supporting the OFDMA technology. How to use the OFDMA technology in the WLAN and to implement backward compatibility with the legacy devices is a technical problem to be solved urgently.

As for the above-mentioned problems about data transmission and backward compatibility in the related art, in the present embodiment, a data transmission method is provided. The data transmission method includes the following steps.

A primary node obtains a transmission opportunity and sends a radio frame to at least one secondary node. In the radio frame, a signalling field of a physical frame header is used to indicate that the radio frame is transmitted in an OFDMA transmission mode.

The secondary node may be composed in multiple modes. For example, there may be one or more second-class secondary nodes, or there may be a first-class secondary node and one or more second-class secondary nodes.

The radio frame sent to the secondary node by the primary node refers to a radio frame transmitted, by the primary node, to multiple nodes in parallel on a working channel supported by the primary node. Sending channels for parallel radio frames sent to the secondary nodes by the primary node includes a main channel of the primary node. When the at least one secondary node includes a first-class secondary node, a sending channel for a radio frame sent to the first-class secondary node by the primary node needs to include the main channel of the primary node.

The signalling field of the radio frame may include at least one of: an L-SIG, an HT-SIG, a VHT-SIG, and an HE-SIG.

Indication using the signalling field of the physical frame header refers to indication using one or more bits in the signalling field. The one or more bits may be preserved bits in the L-SIG, and/or HT-SIG, and/or VHT-SIG, and/or HE-SIG, or preserved values of existing fields.

When the primary node sends parallel radio frames to the secondary nodes in the OFDMA transmission mode, the formats of the OFDMA frames sent to the secondary nodes by the primary node may adopt multiple formats. For example, the following three formats may be adopted, namely formats “1-a”, “1-b” and “2-a”.

The format “1-a” refers to a format in which a signalling field sent to a second-class node by the primary node directly follow a signalling field of a first-class device.

The format “1-b” refers to a format in which the primary node adds a channel estimation sequence ahead of the signalling field for the second-class node.

The format “2-a” refers to a format in which the primary node only contains the signalling field for the second-class node. A signalling field of a second-class device contains at least one of the following information: usage band range indication information of the one or more second-class secondary nodes, and identity authentication information of the one or more second-class secondary nodes.

By means of the above-mentioned data transmission method, data transmission can be performed in the WLAN in an OFDMA mode, and at the same time the solution is compatible to a legacy WLAN device. The network efficiency can be effectively improved.

Exemplary implementation modes of the present disclosure will be illustrated below.

Exemplary Implementation Mode 1

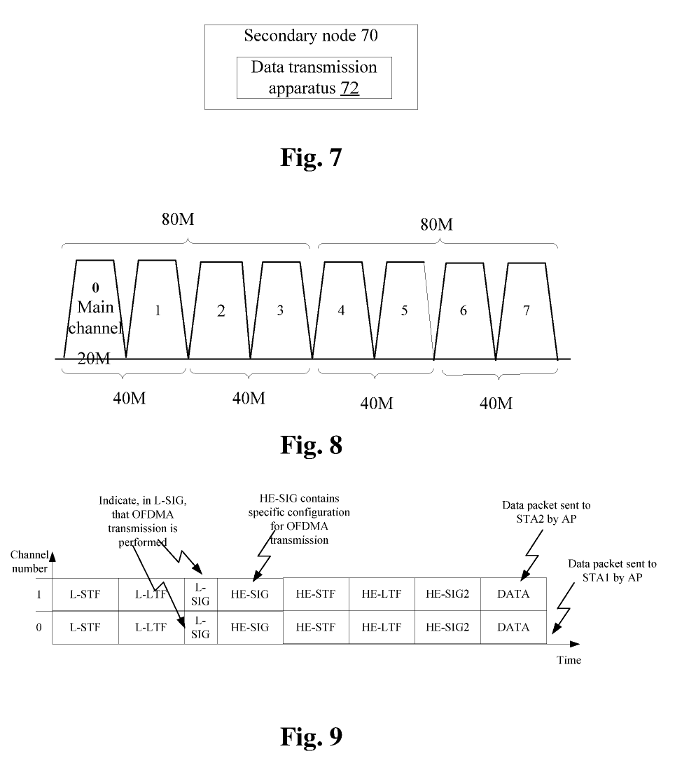

Firstly, a usable channel planning situation for OFDMA transmission is defined. FIG. 8 is a schematic diagram of channel planning for OFDMA transmission according to an embodiment of the present disclosure. As shown in FIG. 8, a maximum running bandwidth supported by the WLAN is 160 MHz, each 20 MHz is a sub-channel, and the numbers of the sub-channels are marked as 0, 1, 2, 3, 4, 5, 6 and 7 respectively. A main channel of a BSS is a No. 0 sub-channel. Channel planning may be used for defining four 40 MHz channels and two 80 MHz channels.

In the present implementation mode, an AP and multiple non-AP STAs form one BSS. A running bandwidth of the BSS is 40 MHz, including a 20 MHz main channel (marked as No. 0 sub-channel) and a 20 MHz secondary channel (marked as No. 1 sub-channel). Both STA1 and STA2 are second-class secondary nodes supporting an OFDMA technology, and support 40 MHz bandwidth transmission respectively. Defaulted detection channels of all stations at least contain the main channel.

The AP obtains a Transmission Opportunity (TXOP) by contention, and initiates OFDMA transmission to STA1 and STA2. FIG. 9 is a sample graph of OFDMA transmission via a frame format “1-a” according to an embodiment of the present disclosure. As shown in FIG. 9, the AP sends data to STA1 and STA2 by using an OFDMA frame format “1-a”. Data of STA1 is borne and transmitted on the No. 0 sub-channel, and data of STA2 is borne and transmitted on the No. 1 sub-channel.

The AP sends an L-STF, an L-LTF and an L-SIG containing the same information on the sub-channels 0 and 1. One or more bits are used in the L-SIG of the main channel to indicate that this transmission is OFDMA transmission. A signalling field for a second-class secondary node follows the L-SIG and is called as a High Efficiency SIG (HE-SIG). A High Efficiency Short Training Field (HE-STF) for sequence synchronization of multi-antenna transmission, a High Efficiency Long Training Field (HE-LTF) for channel estimation of multi-antenna transmission and a High Efficiency SIGNAL 2 (HE-SIG2) for expansion signalling notification of multi-antenna transmission follow the HE-SIG. Data is arranged at the end.

STA1 starts to receive on the No. 0 sub-channel. Firstly, a frame header part is detected, which includes a Legacy Short Training Field (L-STF) for device synchronization, a Legacy Long Training Field (L-LTF) for channel estimation, and an L-SIG for signalling indication of a legacy device.

After detecting the L-STF, STA1 starts to receive on the No. 0 sub-channel and the No. 1 sub-channel simultaneously. One or more bits in the L-SIG of the No. 0 sub-channel indicate that this transmission is OFDMA parallel transmission, and STA1 continuously detects an exclusive HE-SIG field in the OFDMA frame format.

STA1 decodes identity information and bandwidth allocation information configured therefor by the AP in the HE-SIG of the No. 0 sub-channel, and then receives a data part on the No. 0 sub-channel.

STA2 starts to receive on the No. 0 sub-channel. Firstly, the frame header part is detected, and after STA2 detects the L-STF, STA2 starts to receive on the No. 0 sub-channel and the No. 1 sub-channel simultaneously. One or more bits in the L-SIG of the No. 0 sub-channel indicates that this transmission is OFDMA parallel transmission, and STA1 continuously detects an exclusive HE-SIG field in the OFDMA frame format.

STA1 decodes identity information and bandwidth allocation information configured therefor by the AP in the HE-SIG of the No. 0 sub-channel, and then receives a data part on the No. 1 sub-channel.

Exemplary Implementation Mode 2

An AP and multiple non-AP STAs form one BSS. A running bandwidth of the BSS is 80 MHz, including a 20 MHz main channel (supposed as No. 0 sub-channel) and three 20 MHz secondary channels (marked as No. 1, 2 and 3 sub-channels). STA1 is legacy STA supporting an 11 g standard, which supports a maximum bandwidth of 20 MHz, and STA2 is a station supporting OFDMA transmission, which supports an 80 MHz bandwidth. Defaulted detection channels of all stations at least contain the main channel.

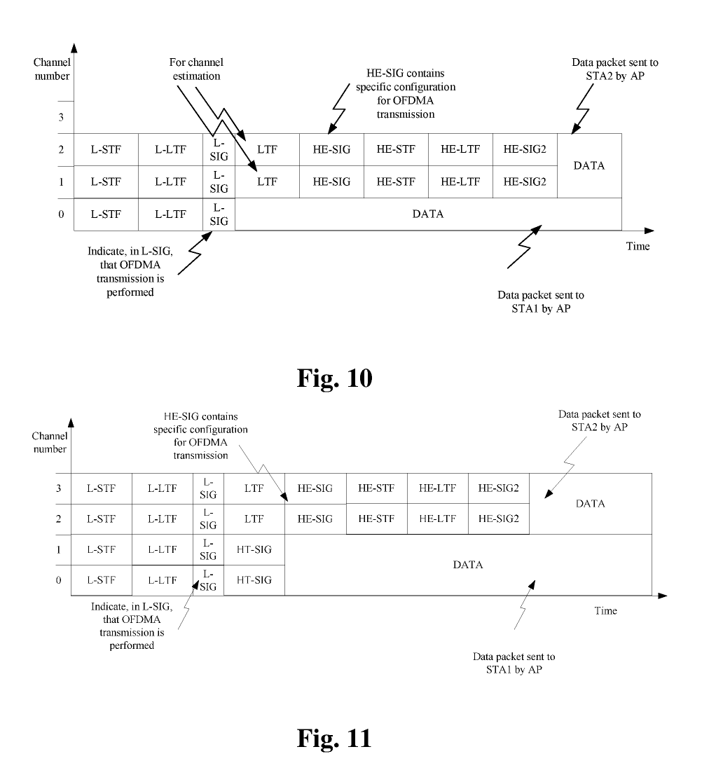

The AP obtains a TXOP by contention, and initiates OFDMA transmission to STA1 and STA2. FIG. 10 is a sample graph 1 of OFDMA transmission via a frame format “1-b” according to an embodiment of the present disclosure. As shown in FIG. 10, the AP sends data to STA1 and STA2 by using an OFDMA frame format “1-b”. Data of STA1 is borne and transmitted on the No. 0 sub-channel, and data of STA2 is borne and transmitted on the No. 1 sub-channel and the No. 2 sub-channel.

STA1 detects an L-STF, an L-LTF and an L-SIG on the main channel in sequence, and receives data sent thereto by the AP on the No. 0 sub-channel.

STA2 detects an L-STF, an L-LTF and an L-SIG on the main channel in sequence. When it is detected that the L-SIG has one or more bits indicating that this transmission is OFDMA transmission, detection starts to be performed on the No. 0 sub-channel, the No. 1 sub-channel, the No. 2 sub-channel and the No. 3 sub-channel simultaneously, effective signals LTF are detected on the No. 1 sub-channel and the No. 2 sub-channel respectively, HE-SIGs on the No. 1 sub-channel and the No. 2 sub-channel are further decoded to obtain identity information and bandwidth allocation information configured therefor by the AP, and remaining data is received on the No. 1 sub-channel and the No. 2 sub-channel.

Exemplary Implementation Mode 3

An AP and multiple non-AP STAs form one BSS. A running bandwidth of the BSS is 80 MHz, including a 20 MHz main channel (supposed as No. 0 sub-channel) and three 20 MHz secondary channels (marked as No. 1, 2 and 3 sub-channels). STA1 is legacy STA supporting an 11n standard, which supports a maximum bandwidth of 40 MHz, and STA2 is a station supporting OFDMA transmission, which supports an 80 MHz bandwidth. Defaulted detection channels of all stations at least contain the main channel.

The AP obtains a TXOP by contention, and initiates OFDMA transmission to STA1 and STA2. FIG. 11 is a sample graph 2 of OFDMA transmission via a frame format “1-b” according to an embodiment of the present disclosure. As shown in FIG. 11, the AP sends data to STA1 and STA2 by using an OFDMA frame format “1-b”. Data of STA1 is borne and transmitted on the No. 0 sub-channel and the No. 1 sub-channel, and data of STA2 is borne and transmitted on the No. 2 sub-channel and the No. 3 sub-channel.

STA1 detects an L-STF, an L-LTF, an L-SIG and an HT-SIG on the main channel in sequence, detects, in the HT-SIG, that a transmission bandwidth indication is 40 MHz, and receives data sent thereto by the AP on the No. 0 sub-channel and the No. 1 sub-channel according to the bandwidth indication.

STA2 detects an L-STF, an L-LTF and an L-SIG on the main channel in sequence. When it is detected that the L-SIG has one or more bits indicating that this transmission is OFDMA transmission, detection starts to be performed on the No. 0 sub-channel, the No. 1 sub-channel, the No. 2 sub-channel and the No. 3 sub-channel simultaneously, effective signals LTF are detected on the No. 2 sub-channel and the No. 3 sub-channel respectively, HE-SIGs on the No. 2 sub-channel and the No. 3 sub-channel are further decoded to obtain identity information and bandwidth allocation information configured therefor by the AP, and remaining data is received on the No. 2 sub-channel and the No. 3 sub-channel.

Exemplary Implementation Mode 4

An AP and multiple non-AP STAs form one BSS. A running bandwidth of the BSS is 80 MHz, including a 20 MHz main channel (supposed as No. 0 sub-channel) and three 20 MHz secondary channels (marked as No. 1, 2 and 3 sub-channels). STA1 is legacy STA supporting an 11ac standard, which supports a maximum bandwidth of 40 MHz, and STA2 is a station supporting OFDMA transmission, which supports an 80 MHz bandwidth. Defaulted detection channels of all stations at least contain the main channel.

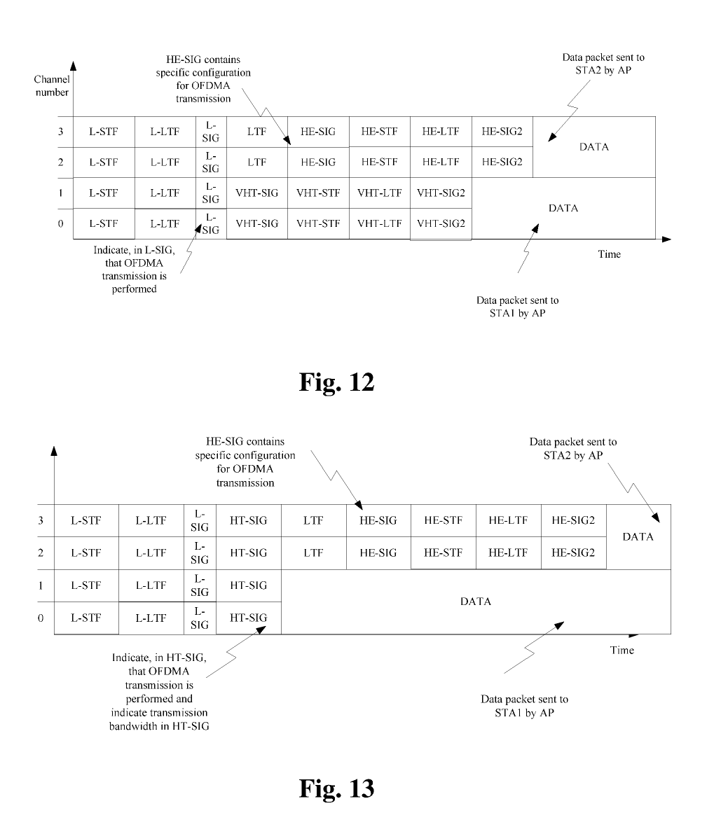

The AP obtains a TXOP by contention, and initiates OFDMA transmission to STA1 and STA2. FIG. 12 is a sample graph 3 of OFDMA transmission via a frame format “1-b” according to an embodiment of the present disclosure. As shown in FIG. 12, the AP sends data to STA1 and STA2 by using an OFDMA frame format “1-b”. Data of STA1 is borne and transmitted on the No. 0 sub-channel and the No. 1 sub-channel, and data of STA2 is borne and transmitted on the No. 2 sub-channel and the No. 3 sub-channel.

STA1 detects an L-STF, an L-LTF, an L-SIG and a VHT-SIG on the main channel in sequence, detects, in the VHT-SIG, that a transmission bandwidth indication is 40 MHz, and receives data sent thereto by the AP on the No. 0 sub-channel and the No. 1 sub-channel according to the bandwidth indication.

STA2 detects an L-STF, an L-LTF and an L-SIG on the main channel in sequence. When it is detected that the L-SIG has one or more bits indicating that this transmission is OFDMA transmission, detection starts to be performed on the No. 0 sub-channel, the No. 1 sub-channel, the No. 2 sub-channel and the No. 3 sub-channel simultaneously, effective signals LTF are detected on the No. 2 sub-channel and the No. 3 sub-channel respectively, HE-SIGs on the No. 2 sub-channel and the No. 3 sub-channel are further decoded to obtain identity information and bandwidth allocation information configured therefor by the AP, and remaining data is received on the No. 2 sub-channel and the No. 3 sub-channel.

Exemplary Implementation Mode 5

An AP and multiple non-AP STAs form one BSS. A running bandwidth of the BSS is 80 MHz, including a 20 MHz main channel (supposed as No. 0 sub-channel) and three 20 MHz secondary channels (marked as No. 1, 2 and 3 sub-channels). STA1 is legacy STA supporting an 11n standard, which supports a maximum bandwidth of 40 MHz, and STA2 is an HEW station supporting OFDMA transmission and an 80 MHz bandwidth. Defaulted detection channels of all stations at least contain the main channel.

The AP obtains a TXOP by contention, and initiates OFDMA transmission to STA1 and STA2. FIG. 13 is a sample graph 4 of OFDMA transmission via a frame format “1-b” according to an embodiment of the present disclosure. As shown in FIG. 13, the AP sends data to STA1 and STA2 by using an OFDMA frame format “1-b”. Data of STA1 is borne and transmitted on the No. 0 sub-channel and the No. 1 sub-channel, and data of STA2 is borne and transmitted on the No. 2 sub-channel and the No. 3 sub-channel.

STA1 detects an L-STF, an L-LTF, an L-SIG and an HT-SIG on the main channel in sequence, detects, in the HT-SIG, that a transmission bandwidth indication is 40 MHz, and receives data sent thereto by the AP on the No. 0 sub-channel and the No. 1 sub-channel according to the bandwidth indication.

STA2 detects an L-STF, an L-LTF, an L-SIG and an HT-SIG on the main channel in sequence. The HT-SIG has one or more bits indicating that this transmission uses an OFDMA frame formats and a bandwidth indication is 40 MHz. Detection starts to be performed on the No. 2 sub-channel and the No. 3 sub-channel beyond the bandwidth indication, effective signals LTF are detected on the No. 2 sub-channel and the No. 3 sub-channel respectively, HE-SIGs on the No. 2 sub-channel and the No. 3 sub-channel are further decoded to obtain identity information and bandwidth allocation information configured therefor by the AP, and remaining data is received on the No. 2 sub-channel and the No. 3 sub-channel.

Exemplary Implementation Mode 6

An AP and multiple non-AP STAs form one BSS. A running bandwidth of the BSS is 80 MHz, including a 20 MHz main channel (supposed as No. 0 sub-channel) and three 20 MHz secondary channels (marked as No. 1, 2 and 3 sub-channels). STA1 is legacy STA supporting an 11ac standard, which supports a maximum bandwidth of 40 MHz, and STA2 is a station supporting OFDMA transmission and supporting an 80 MHz bandwidth. Defaulted detection channels of all stations at least contain the main channel.

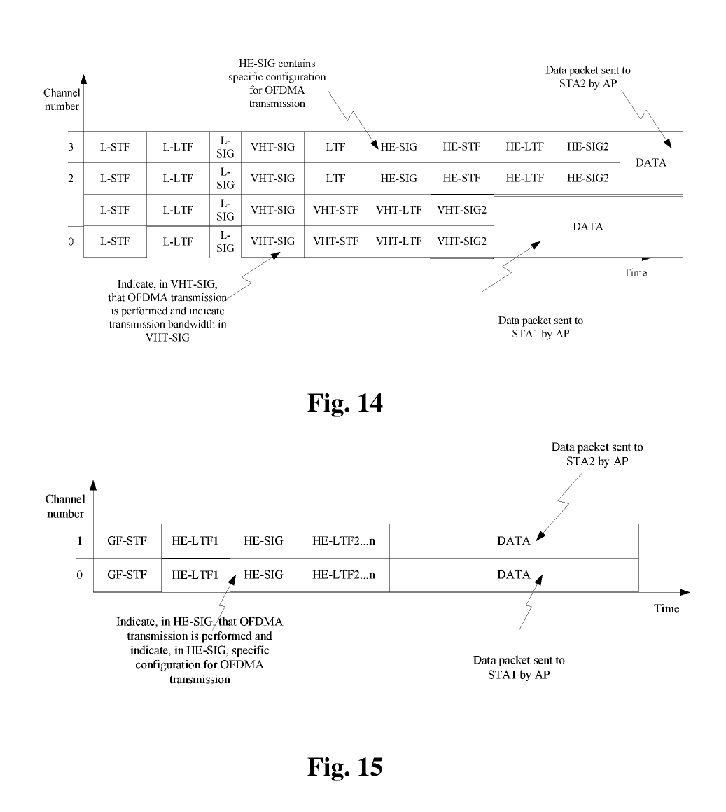

The AP obtains a TXOP by contention, and initiates OFDMA transmission to STA1 and STA2. FIG. 14 is a sample graph 5 of OFDMA transmission via a frame format “1-b” according to an embodiment of the present disclosure. As shown in FIG. 14, the AP sends data to STA1 and STA2 by using an OFDMA frame format “1-b” (as shown in FIG. 8). Data of STA1 is borne and transmitted on the No. 0 sub-channel and the No. 1 sub-channel, and data of STA2 is borne and transmitted on the No. 2 sub-channel and the No. 3 sub-channel.

STA1 detects an L-STF, an L-LTF, an L-SIG and a VHT-SIG on the main channel in sequence, detects, in the VHT-SIG, that a transmission bandwidth indication is 40 MHz, and receives data sent thereto by the AP on the No. 0 sub-channel and the No. 1 sub-channel according to the bandwidth indication.

STA2 detects an L-STF, an L-LTF, an L-SIG and a VHT-SIG on the main channel in sequence. The VHT-SIG has one or more bits indicating that this transmission uses an OFDMA frame formats and a bandwidth indication is 40 MHz. Detection starts to be performed on the No. 2 sub-channel and the No. 3 sub-channel beyond the bandwidth indication, LTFs are detected on the No. 2 sub-channel and the No. 3 sub-channel respectively, HE-SIGs on the two channels are further detected to obtain configuration information of this OFDMA transmission, and data sent thereto by the AP is continuously received on the No. 2 sub-channel and the No. 3 sub-channel.

Exemplary Implementation 7

An AP and multiple non-AP STAs form one BSS. The BSS only contains a second-class secondary node supporting an OFDMA technology. A running bandwidth of the BSS is 40 MHz, including a 20 MHz main channel (marked as No. 0 sub-channel) and a 20 MHz secondary channel (marked as No. 1 sub-channel). STA1 and STA2 support 40 MHz bandwidth transmission respectively. Defaulted detection channels of all stations at least contain the main channel.

The AP obtains a TXOP by contention, and initiates OFDMA transmission to STA1 and STA2. FIG. 15 is a sample graph of OFDMA transmission via a frame format “2-a” according to an embodiment of the present disclosure. As shown in FIG. 15, the AP sends data to STA1 and STA2 by using an OFDMA frame format “2-a”. Data of STA1 is borne and transmitted on the No. 0 sub-channel, and data of STA2 is borne and transmitted on the No. 1 sub-channel.

The AP sends a Green Field STF (GF-STF), HE-LTF1 and HE-SIG containing the same information on the sub-channels 0 and 1. One or more bits are used in the HE-SIG to indicate that this transmission is OFDMA transmission. Meanwhile, the HE-SIG further contains all pieces of user information and channel configuration information of this OFDMA transmission. HE-LTF2, HE-LTF3, . . . , HE-LTFn follows the HE-SIG, the value of n being associated with multi-antenna configuration. These LTF fields are used for channel estimation for multi-antenna configuration. Data is arranged at the end.

STA1 starts to receive on the No. 0 sub-channel. Firstly, a frame header part is detected, which includes a GF-STF for device synchronization when only second-class sub-nodes exist in the BSS, HT-LTF1 for channel estimation, and an HE-SIG for signalling indication of second-class sub-nodes.

STA1 detects, in the HE-SIG, that one or more bits indicate that this transmission uses an OFDMA frame format, and obtains configuration information of this OFDMA transmission. The configuration information indicates that data sent to STA1 is on the No. 0 sub-channel, so STA1 continuously receives data on the No. 0 sub-channel.

STA2 starts to receive on the No. 0 sub-channel, and detects a GF-STF, HT-LTF1 and HE-SIG in sequence. In the HE-SIG, it is detected that one or more bits indicate that this transmission uses an OFDMA frame format, and configuration information of this OFDMA transmission is obtained. The configuration information indicates that data sent to STA2 is on the No. 1 sub-channel, so STA2 turns to receive data on the No. 1 sub-channel.

Obviously, those skilled in the art shall understand that all of the above-mentioned modules or steps in the embodiments of the present disclosure may be implemented by using a general calculation apparatus, may be centralized on a single calculation apparatus or may be distributed on a network composed of multiple calculation apparatuses. Alternatively, they may be implemented by using executable program codes of the calculation apparatuses. Thus, they may be stored in a storage apparatus and executed by the calculation apparatuses, the shown or described steps may be executed in a sequence different from the sequence under certain conditions, or they are manufactured into each integrated circuit module respectively, or multiple modules or steps therein are manufactured into a single integrated circuit module. Thus, the present disclosure is not limited to combination of any specific hardware and software.

The above is only the exemplary embodiments of the present disclosure, and not intended to limit the present disclosure. There may be various modifications and variations in the present disclosure for those skilled in the art. Any modifications, equivalent replacements, improvements and the like made within the principle of the present disclosure shall fall within the scope of protection defined by the appended claims of the present disclosure.

### INDUSTRIAL APPLICABILITY

As above, by means of the above-mentioned embodiments and exemplary implementation modes, the problems of low efficiency and waste of resources existing in data transmission of a WLAN in the related art are solved. The effect of improving network efficiency effectively can be achieved by using an OFDMA transmission mode in the WLAN.

1. A data transmission method, comprising:
obtaining a data transmission opportunity; and
sending a radio frame to at least one secondary node, wherein a signalling field of the radio frame contains indication information used for indicating that the radio frame is transmitted via an Orthogonal Frequency Division Multiple Access (OFDMA) transmission mode.

2. The data transmission method as claimed in claim 1, wherein the at least one secondary node comprises the following combination modes:
one or more second-class secondary nodes supporting an OFDMA transmission technology, and one or more first-class secondary nodes; and
one or more second-class secondary nodes supporting an OFDMA transmission technology.

3. The data transmission method as claimed in claim 1, wherein the signalling field of the radio frame comprises at least one of:
a Legacy SIGNAL (L-SIG), a High-Throughput SIGNAL (HT-SIG), a Very-High-Throughput SIGNAL (VHT-SIG), and a High-Effective SIGNAL (HE-SIG).

4. The data transmission method as claimed in claim 2, wherein the radio frame is sent to the one or more second-class secondary nodes in the at least one secondary node in a predetermined format, the predetermined format comprising at least one of:
a format 1-a in which a signalling field corresponding to the one or more second-class secondary nodes is located after a signalling field corresponding to the one or more first-class secondary nodes;
a format 1-b in which a channel estimation sequence is added ahead of a signalling field corresponding to the one or more second-class secondary nodes; and
a format 2-a in which only a signalling field corresponding to the one or more second-class secondary nodes is contained.

5. The data transmission method as claimed in claim 2, wherein the signalling field of the radio frame further comprises at least one of:
usage band range information of the one or more second-class secondary nodes in the at least one secondary node, and identity authentication information of the one or more second-class secondary nodes.

6. A data transmission method, comprising:
receiving a radio frame sent by a primary node, wherein a signalling field of the radio frame contains indication information used for indicating that the radio frame is transmitted via an Orthogonal Frequency Division Multiple Access (OFDMA) transmission mode;
detecting, over a main channel of the primary node, that a transmission mode of current transmission is the OFDMA transmission mode;
acquiring, according to detection on the main channel, information of a corresponding channel used for transmitting data by the primary node; and
acquiring the data transmitted by the primary node on the corresponding channel.

7. The data transmission method as claimed in claim 6, wherein the signalling field of the radio frame comprises at least one of:
a Legacy SIGNAL (L-SIG), a High-Throughput SIGNAL (HT-SIG), a Very-High-Throughput SIGNAL (VHT-SIG), and a High-Effective SIGNAL (HE-SIG).

8. The data transmission method as claimed in claim 6, wherein the radio frame sent by the primary node is received in a predetermined format, the predetermined format comprising at least one of:
a format 1-a in which a signalling field corresponding to one or more second-class secondary nodes is located after a signalling field corresponding to one or more first-class secondary nodes;
a format 1-b in which a channel estimation sequence is added ahead of a signalling field corresponding to one or more second-class secondary nodes; and
a format 2-a in which only a signalling field corresponding to one or more second-class secondary nodes is contained.

9. The data transmission method as claimed in claim 6, wherein the signalling field of the radio frame further comprises at least one of:
usage band range information of one or more second-class secondary nodes, and identity authentication information of one or more second-class secondary nodes.

10. A data transmission apparatus, comprising a hardware processor arranged to execute the following program modules:
an obtaining module, arranged to obtain a data transmission opportunity; and
a sending module, arranged to send a radio frame to at least one secondary node, wherein a signalling field of the radio frame contains indication information used for indicating that the radio frame is transmitted via an Orthogonal Frequency Division Multiple Access (OFDMA) transmission mode.

11. A primary node, comprising the data transmission apparatus as claimed in claim 10.

12. A data transmission apparatus, comprising hardware processor arranged to execute the following program modules:
a receiving module, arranged to receive a radio frame sent by a primary node, wherein a signalling field of the radio frame contains indication information used for indicating that the radio frame is transmitted via an Orthogonal Frequency Division Multiple Access (OFDMA) transmission mode;
a detection module, arranged to detect, over a main channel of the primary node, that a transmission mode of current transmission is the OFDMA transmission mode;
a first acquisition module, arranged to acquire, according to detection on the main channel, information of a corresponding channel used for transmitting data by the primary node; and
a second acquisition module, arranged to acquire the data transmitted by the primary node on the corresponding channel.

13. A secondary node, supporting an Orthogonal Frequency Division Multiple Access (OFDMA) transmission technology, and comprising the data transmission apparatus as claimed in claim 12.

14. The data transmission apparatus as claimed in claim 10, wherein the at least one secondary node comprises the following combination modes:
one or more second-class secondary nodes supporting an OFDMA transmission technology, and one or more first-class secondary nodes; and
one or more second-class secondary nodes supporting an OFDMA transmission technology.

15. The data transmission apparatus as claimed in claim 10, wherein the signalling field of the radio frame comprises at least one of:
a Legacy SIGNAL (L-SIG), a High-Throughput SIGNAL (HT-SIG), a Very-High-Throughput SIGNAL (VHT-SIG), and a High-Effective SIGNAL (HE-SIG).

16. The data transmission apparatus as claimed in claim 14, wherein the sending module is arranged to send the radio frame the one or more second-class secondary nodes in the at least one secondary node in a predetermined format, the predetermined format comprising at least one of:
a format 1-a in which a signalling field corresponding to the one or more second-class secondary nodes is located after a signalling field corresponding to the one or more first-class secondary nodes;
a format 1-b in which a channel estimation sequence is added ahead of a signalling field corresponding to the one or more second-class secondary nodes; and
a format 2-a in which only a signalling field corresponding to the one or more second-class secondary nodes is contained.

17. The data transmission apparatus as claimed in claim 14, wherein the signalling field of the radio frame further comprises at least one of:
usage band range information of the one or more second-class secondary nodes in the at least one secondary node, and identity authentication information of the one or more second-class secondary nodes.

18. The data transmission apparatus as claimed in claim 12, wherein the signalling field of the radio frame comprises at least one of:
a Legacy SIGNAL (L-SIG), a High-Throughput SIGNAL (HT-SIG), a Very-High-Throughput SIGNAL (VHT-SIG), and a High-Effective SIGNAL (HE-SIG).

19. The data transmission apparatus as claimed in claim 12, wherein the receiving module is arranged to receive the radio frame sent by the primary node in a predetermined format, the predetermined format comprising at least one of:
a format 1-a in which a signalling field corresponding to one or more second-class secondary nodes is located after a signalling field corresponding to one or more first-class secondary nodes;
a format 1-b in which a channel estimation sequence is added ahead of a signalling field corresponding to one or more second-class secondary nodes; and
a format 2-a in which only a signalling field corresponding to one or more second-class secondary nodes is contained.

20. The data transmission apparatus as claimed in claim 12, wherein the signalling field of the radio frame further comprises at least one of:
usage band range information of one or more second-class secondary nodes, and identity authentication information of one or more second-class secondary nodes.
